(19) United States
(12) Patent Application Publication
(10) Pub. No.: US 2009/0185669 A1
(43) Pub. Date: Jul. 23, 2009

(54) System and method for karaoke style ringback tones and karaoke style ringtones

(76) Inventors: Stephen J. Zitnik, Fort Myers, FL (US); William H. Buch, Cape Coral, FL (US); Roy B. Rigas, Fort Myers, FL (US)

Correspondence Address: COOK ALEX LTD, SUITE 2850, 200 WEST ADAMS STREET, CHICAGO, IL, 60606, US

(21) Appl. No.: 11/450,134

(22) Filed: Jun. 9, 2006

Related U.S. Application Data
(60) Provisional application No. 60/689,159, filed on Jun. 9, 2005.
(60) Provisional application No. 60/720,666, filed on Sep. 26, 2005.

(51) Int. Cl. H04M 3/42

(52) U.S. Cl. 379/217.01; 455/567

(57) ABSTRACT

A system and method are described for permitting a telephone user to customize the identification of a call setup process. The telephone user is permitted to create a karaoke style recording by causing an underlying musical track to be mixed with the voice of the user. The karaoke style recording is stored for later use as a ringback tone and/or ringtone, as desired, to identify the call setup process.

### CROSS-REFERENCE TO RELATED APPLICATIONS

This application claims priority from and the benefit of U.S. Provisional Application No. 60/689,159, filed Jun. 9, 2005, the disclosure of which is hereby incorporated herein by reference. This application also claims priority from and the benefit of U.S. Provisional Application No. 60/720,666, filed Sep. 26, 2005, the disclosure of which is also hereby incorporated herein by reference.

### BACKGROUND OF THE INVENTION

The present invention is generally directed to ringback tone technology and ringtone technology. More particularly, the present invention is directed to a system and method for allowing a wireless or wireline telephone service subscriber to record his own voice over existing audio recordings, or as a stand alone audio recording, to create a unique audio file that can be converted into a format suitable for play as a ringback tone and/or as a ringtone for a mobile handset. The audio file can be in the form of a karaoke style audio file.

The underlying technology relates to what is referred to as ringback technology and what is referred to as ringtone technology. Traditionally, a ringback is a simulated ringing sound that a calling party hears when he calls another phone. This simulated sound is heard by the calling party until such time as the called party answers his phone or upon occurrence of a similar event that would terminate the ringback process.

A ringtone, on the other hand, is a simulated ringing sound played by a called telephone to alert for an incoming call. This simulated sound is heard by the called party until such time as the called party answers his phone or upon occurrence of a similar event that would terminate the ringing process (such as delivery of the call into a voicemail response system).

The latest ringback technology allows a cellular phone service subscriber to customize his ringback. When someone calls that cellular phone customer, the calling party will hear the customized ringback.

Similarly, the latest ringtone technology allows a cellular phone service subscriber to customize his ringtone. When someone calls that cellular phone customer, the customer will hear the customized ringtone. Examples of popular customized ringback tones and ringtones include songs, commentary of favorite sports moments, etc.

With existing technology, wireless subscribers have not had the ability to create, manage and play karaoke style ringback tones and/or ringtones where a karaoke style audio file is created by the subscriber for later use as a ringback tone and/or a ringtone. Traditional karaoke is extremely popular. Existing ringback tone and ringtone technologies have failed to capitalize on the popularity of karaoke.

In view of the foregoing, there is a need to capitalize on the popularity of karaoke style music in the customized ringback tone market.

There is also a need to capitalize on the popularity of karaoke style music in the customized ringtone market.

There is also a need to provide a system and method permitting a subscriber to create, manage and play karaoke style ringback tones.

There is also a need to provide a system and method permitting a subscriber to create, manage and play karaoke style ringtones.

There is also a need to permit the creation of karaoke style audio files using wireless handset devices.

The aforementioned needs are not necessarily all-inclusive. Furthermore, the benefits derived from the preferred forms of the invention, as described herein, are not limiting. Additional benefits will become apparent from the following description. It should also be understood that an apparatus and/or method could still appropriate the invention claimed herein without accomplishing each and every expressed or implied benefit of the preferred forms of the invention. The appended claims, not the benefits, define the subject matter of this invention. Any and all benefits are derived from the preferred forms of the invention, not necessarily the invention in general.

### BRIEF SUMMARY OF THE INVENTION

The technologies described herein fulfill the aforementioned needs. With the present invention, wireless or potentially wirline telephone customers can combine musical tracks with their own voice, to create truly personalized ringback tone and/or ringtone content. The present invention creates and permits use of a truly personalized ringback tone and/or ringtone. Content created by the user is stored as one or more karaoke style audio files and immediately available for use as ringback content and/or ringtone content. The creation, management and use of customized ringback tones and/or ringtones in the form of one or more pre-recorded karaoke style audio files is enabled. When used as a ringback tone, an audio recording of a cellular subscriber's voice mixed with a song recording can be. heard by the calling party while awaiting the response to the call. When used as a ringtone, an audio recording of a cellular subscriber's voice mixed with a song recording is played while awaiting the response to the call. Preferably, with the present invention, the subscriber is also permitted to post a link on a website, preferably a publicly available and accessible website, to enable streaming of the created karaoke style audio file for comment and/or voting.

In the described embodiments, the system of the present invention includes server hardware and server and client software permitting the creation, management, and use (playback) of these individualized recordings through interactive voice response (IVR), personal computer (PC) desktop application, web, and wireless handset based interfaces.

### BRIEF DESCRIPTION OF THE DRAWINGS

In the following detailed description, reference will frequently made to the following figures, in which like reference numerals refer to like components, and in which:

FIG. 1 is a diagrammatic view illustrating a basic configuration of a platform designed in a manner such that it may carry out the principles of the present invention;

FIG. 2 is a diagrammatic view illustrating a central services model for carrying out the principles of the present invention;

FIG. 3 is a diagrammatic view illustrating a decentralized services model for carrying out the principles of the present invention;

FIG. 4 is a flow diagram illustrating a method of carrying out principles of the present invention;

FIG. 5 is another flow diagram illustrating a method of carrying out principles of the present invention;

FIG. 6 is a flow diagram illustrating another method of carrying out principles of the present invention;

FIG. 7 is a flow diagram illustrating another method of carrying out principles of the present invention;

FIG. 8 is a flow diagram illustrating another method of carrying out principles of the present invention;

FIG. 9A is a flow diagram illustrating a configuration for carrying out principles of the present invention;

FIG. 9B is a drawing representative of a graphical user interface that may be used to carry out principles of the present invention;

FIG. 10 is a flow diagram illustrating another configuration for carrying out principles of the present invention; and

FIG. 11 is a flow diagram illustrating another configuration for carrying out principles of the present invention.

### DETAILED DESCRIPTION OF THE INVENTION

As described herein, hardware and software can be used to create, manage, and play individualized, customized karaoke style recordings through interactive voice response, personal computer desktop application, and web based interfaces. The created audio file is a karaoke style audio file that can be used as a ringback tone and/or as a ringtone. The same recorded karaoke style audio file can serve as a ringtone and ringback tone for the subscriber, or alternatively, different ringtones and ringback tones can be used, including two or more different karaoke style audio files used for those purposes.

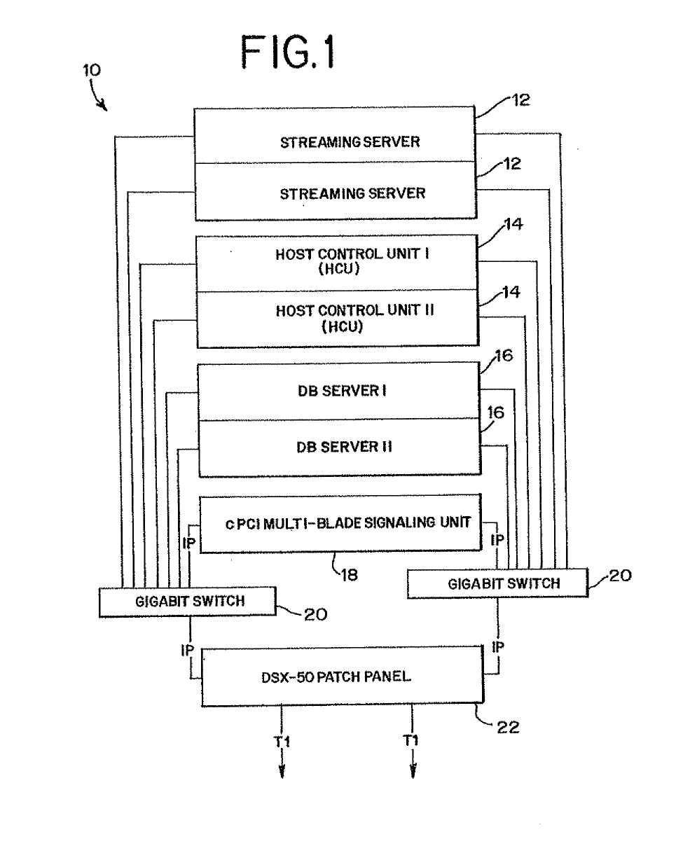

Four types of client applications and methods for tone creation are described herein: messaging driven IVR, web or wireless application protocol (WAP) driven IVR, PC applications, and handset based client applications. These methods, while each unique, preferably utilize the same underlying server architecture 10, shown illustratively in FIGS. 1-3, as including streaming servers 12, host controller units (HCU) 14, database clusters (DB) 16, and compact PCI (cPCI) multi-blade signaling units 18.

The ringback/ringtone content creation and management platform is preferably a highly available, robust and redundant platform, which preferably allows for simple scalability from one to one thousand forty-eight T-1/E-1 links in its base configuration. In addition, the platform 10 offers streaming technology, allowing carriers to offer an unlimited number of content types and individual content pieces to their subscribers. The core software preferably provides complete SNMP support on all system monitoring capabilities and has full SIP support compliant with RFC 2543 and SDP RFC 2327 allowing operation in a mixed packet and circuit switched (IMS) environment.

The ringback/ringtone content creation and management platform 10 can be designed in a distributed architecture, allowing individual elements, as well as the system as a whole, to grow effortlessly. Basic networks elements are the aforementioned streaming servers 12, host controller units (HCUs) 14, database (DB) servers 16, and compact PCI (cPCI) multi-blade signaling units 18.

The streaming servers 12 host content and streaming applications. The streaming servers 12 may be in a stacked configuration to provide unlimited content selections. The capability of providing an unlimited number of ringback content types, an unlimited number of ringtone content types, and individual content types to the subscribers is important as ringback and ringtone users are given the ability to create their own content through use of the present invention.

The host controller units 14 provide user application ,and blade control logic. In particular, the host controller units 14 provide the application framework controlling the IVR, as well as the server side component for the WEB, Java and handset based J2ME and BREW based client software, referred to herein. In addition, the host controller units 14 provide for public display of completed tones, as desired. For smaller installations, the host controller units 14 may also include data basing functionality. The host controller units 14 can be mated and/or stacked to provide redundancy and scalability.

The database servers 16 provide storage and database services to manage user accounts, preferences, content choices, and billing information.

The cPCI multi-blade signaling units 18 provide T1/E1 interfaces, as well as SS7/ISUP stacks. Preferably, the minimum configuration provides for eight fully redundant T1/E1 links.

FIG. 1 illustrates a basic configuration of the ringback/ringtone content creation and management platform generally designated 10. As shown, the platform 10 includes streaming servers 12, host control units 14, database servers 16, cPCI multi-blade signaling units 18, gigabit switches 20, and DSX-50 patch panels 22. In the embodiment illustrated in FIG. 1, all system elements are connected via dual gigabit Ethernet switches 20, which provide redundant paths to each network element. Each platform element is mated in a master/slave configuration to provide multi-path and multi-server redundancy. This stackable architecture provides the flexibility to scale system resources, as desired. If content storage space becomes limited, additional streaming servers 12 may be added to increase overall system capacity. Trunk lines, host controller units 14 and database servers 16 may all be scaled in a similar fashion.

The ringback/ringtone content creation and management platform 10 can be connected into a carrier's network using standard T1/E1 links. The recording platform is entirely handset and over-the-air (OTA) technology agnostic. Delivery of ringback tones and ringtones is achieved using industry standard methods over the carriers, pre-existing data network.

The ringback/ringtone content creation and managment platform 10 can be designed to be easily integrated into the carrier's network in a number of configurations. Final network configuration can be dependent upon the carrier's network and trunking preferences. Two anticipated networking scenarios are detailed below, but those skilled in the art will appreciate that other network topologies can be used to complement the carrier's preferred configuration.

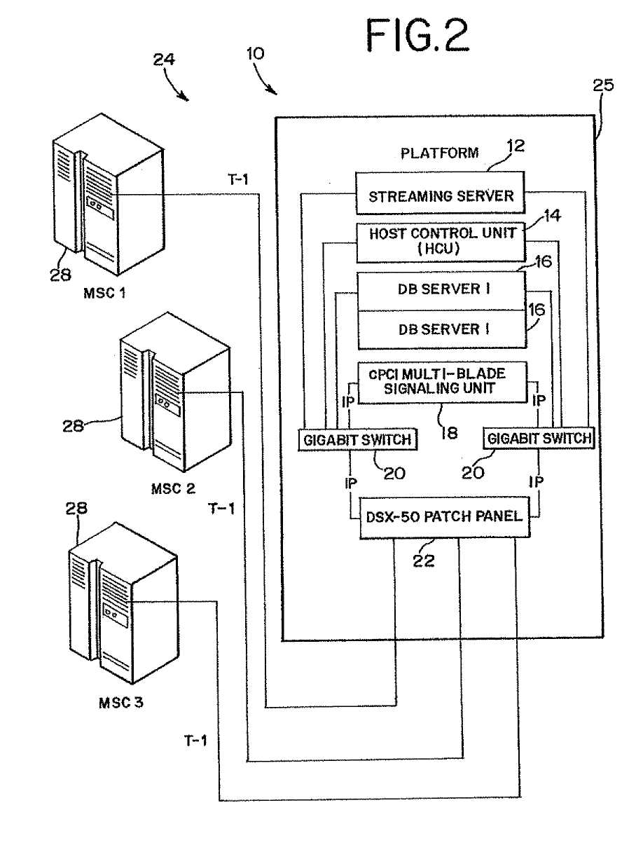

FIG. 2 illustrates a centralized services model 24 for the platform architecture 10. In the turnkey scenario, the hardware is located at a single location within the carrier's network. In the traditional centralized scenario, the hardware is located at a one central office 25. The carrier can carry out the task of trunking traffic from each of its switches to the centralized ringback/ringtone content creation and management platform.

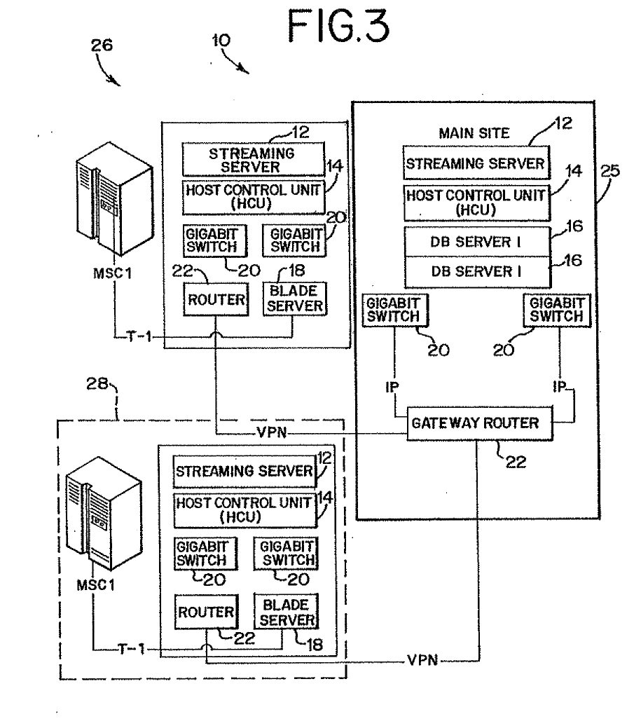

FIG. 3 illustrates a decentralized services model 26 for the platform architecture 10, where network elements are positioned at the edges of the carrier's network. Under this model, each mobile switching center (MSC) 28 or subset of MSCs would have its own streaming server 12, cPCI blade server 18, and host control unit 14 (with integrated local database). In addition, a main site host controller unit 14 and database server cluster 16 would reside at a main site 25 and provide for user management, billing and back up of the local databases.

Three primary clients are described herein as being used in conjunction with the core network technologies listed above for creation of a karaoke style audio files to be used as ringback tones and/or a ringtones, namely an IVR client, a computer(PC) based client, and a handset based client. Software to carry out the present invention may include interactive voice response subsystems to create, manage and support the karaoke style ringback tone and/or ringtone content. IVR implementations may utilize standard TCP/IP, standard ISUP, telephony, and web protocols to achieve the creation of karaoke style audio files to be used as ringback tones and/or ringtones. IVR implementations may support any standard T1/E1 trunking protocols and VOIP/SIP protocols. Such implementations may allow for functionality within an IMS framework. The IVR recording session may be initiated via a number of front end client processes including Web, WAP, SMS, or MMS. In each case, preferably, data between the client and the underlying platform is exchanged to inform the platform of song selection and to authenticate the user. The first described client application is a messaging driven IVR application. The messaging driven IVR interface preferably provides for authentication, song selection and recording process initiation utilizing a simple intuitive messaging dialogue technique, working equally well within a SMS or MMS framework. Subscriber input can be provided via simple short code/keyword pairs culminating in a call to or from the server platform to the subscriber handset for a studio session (i.e., recording).

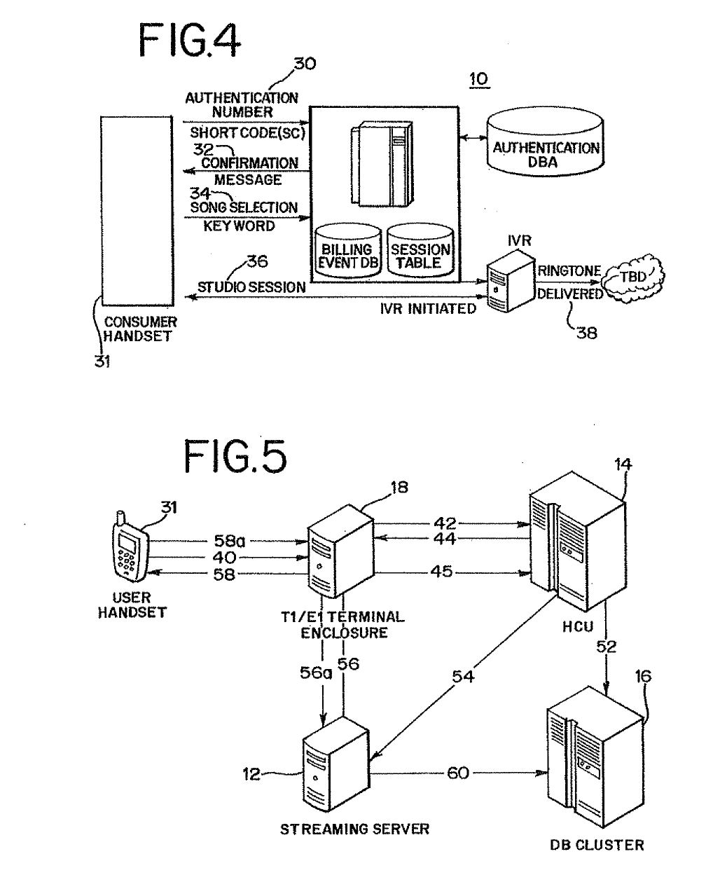

The basic call flow for a preferred authentication and song selection methodology for a messaging driven IVR application is illustrated in FIG. 4. First, at 30, the subscriber sends a message from a handset 31 to the platform in the form of a pre-defined short code using either SMS or MMS with the authentication number (i.e., password). The platform then, at 32, validates the user authentication number and sends back a confirmation message to proceed. The subscriber replies, at 34, to the confirmation message using a pre-defined content short code as the keyword for song selection. Thereafter, the platform initiates, at 36, an IVR session to begin the studio session. The studio session walks the subscriber through the recording process with simple intuitive voice prompts. The platform saves the karaoke style audio file for use as a ringback tone and/or delivers the recorded karaoke content to the handset for use as a ringtone, at 38.

Another diagram reflective of a basic call flow for use of the present invention in a message driven interactive voice response application is illustrated in FIG. 5. As illustrated, at 40, a user places a call to or receives a call from a specific public switched telephone network (PSTN) accessible number having a terminal point as a specific T1/E1 blade in the cPCI blade unit enclosure 18. The blade enclosure 18 notifies the host control unit (HCU) 14 of the incoming call, at 42. At 44, the host control unit 14 instructs the cPCI blade 18 to connect the call to the IVR resource on the HCU. The user is prompted, using standard IVR techniques to authenticate using mobile directory number (MDN) and password information. MDN and password information is used to obtain access to the tone creation service, at 50. If successful authentication is achieved, the database cluster 16 is queried to ascertain if any suitable content has been purchased by the user, at 52. If suitable content exists, the content names are returned to the user using standard IVR techniques. If the user is authenticated and no existing purchased content is available, the user will be allowed to purchase suitable content.

Once suitable content has been identified or purchased, the host control unit 14 via the IVR interface instructs the user that recording is about to begin. In response, at 54, the host control unit sends an instruction to the streaming server 12. In response to receipt of the instruction, at 56, 56a, the streaming server 12 establishes two stream links or resources to the time division multiplexing port on the cPCI blade 18 for use by the handset 31. At 58, 58a, corresponding communication paths are established between the handset 31 and the cPCI blade 18. One path is used for the playback of the recorded undertone, which was stored on the streaming server (56, 58). The other path is used for the recording of the mixed underlying tone and user voice recording (56a, 58a). This mixing and recording of the underlying tone and the user voice recording can be carried out internally in the cPCI blades 18. The system can be designed such that only one physical DSO in fully duplex mode is utilized. Once the connections are achieved the user sings (or speaks) over the playback of the underlying tone to create a new unique tone. This karaoke style audio file is then either stored on the streaming server 12, delivered to the handset or delievered to the legacy RBT platform, at 60, and is available for use as a ringback tone and/or for download to a handset for use as a ringtone.

The second described client application is a web or wireless application protocol driven IVR application. The interface may provide for authentication, song selection and recording process initiation utilizing standard browser agnostic web technologies. The web interface may be used to select and review available content, as well as initiate the studio session for recording. Due to the nature of the medium, the web interface provides for a richer set of media choices, as well as the added benefit of lyric presentation and lyric scrolling resembling the live karaoke performance experience. Additionally, the web interface allows users who have elected to create their tones using the SMS method, to post those tones, along with their comments to a publicly accessible webpage for public review and rating.

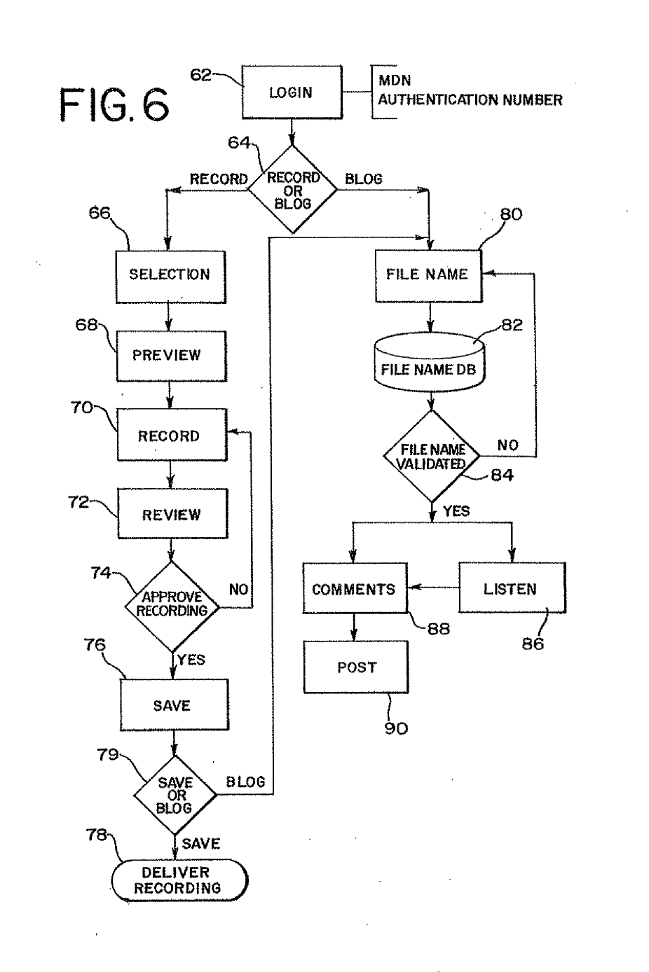

A representative process for a web or wireless application protocol driven IVR application leading up to the initiation of the recording process is illustrated in FIG. 6. The user logs on to the hosted website, preferably by providing mobile directory number and authentication number information, at 62. After login, at 64, users have the option of selecting either a recording session or a Blogging ( or posting)session. If the recording session is selected, the user may select a prerecorded underlying audio track, at 66, and preview the track, at 68. In that regard, song preview and lyric sheets are available for browsing. The user may enter a unique filename and a callback number. The IVR system then places a call to the provided callback number, and the studio session is then initiated to walk the user through the recording process. It is also possible to allow for the user to call in to the platform utilizing a personal identification number PIN.

During the studio session, the user is able to record the karaoke style audio file using the selected underlying music track, at 70. Following recordation, at 72 and 74, the user may review and approve or disapprove of the recording by appropriate playback and using standard IVR functions. Should the user choose to disapprove of the recorded karaoke style audio file, the user may initiate another recording session. Once approved by the user, the recorded karaoke style audio file may be saved, at 76, and stored for use as a ringback tone and/or subsequently downloaded to the handset for use as a ringtone, at 78.

The user is also permitted to initiate a Blogging session, at 64 and 79. During a Blogging session, the user identifies a file name associated with a prerecorded audio file, at 80, which identification may be carried out as simply as having the user point and click a hyperlink associated with the file. The audio file is retrieved, at 82, and validated, at 84, and may then be reviewed by the user, at 86. The user may then comment on the recording, at 88, and post such comments on a publicly accessible webpage, at 90.

It will be understood that use of the described IVR client applications for recordation of a karaoke style audio file over the referenced telecommunication networks will inherently be subject to network latency. While network latency is not immediately apparent in normal everyday voice conversations, it will be appreciated that high latency levels can affect the performance of the IVR platform during creation of the karaoke style audio files through use of a handset interface. For instance, network latency may skew the synchronicity of the user's voice and the underlying music track.

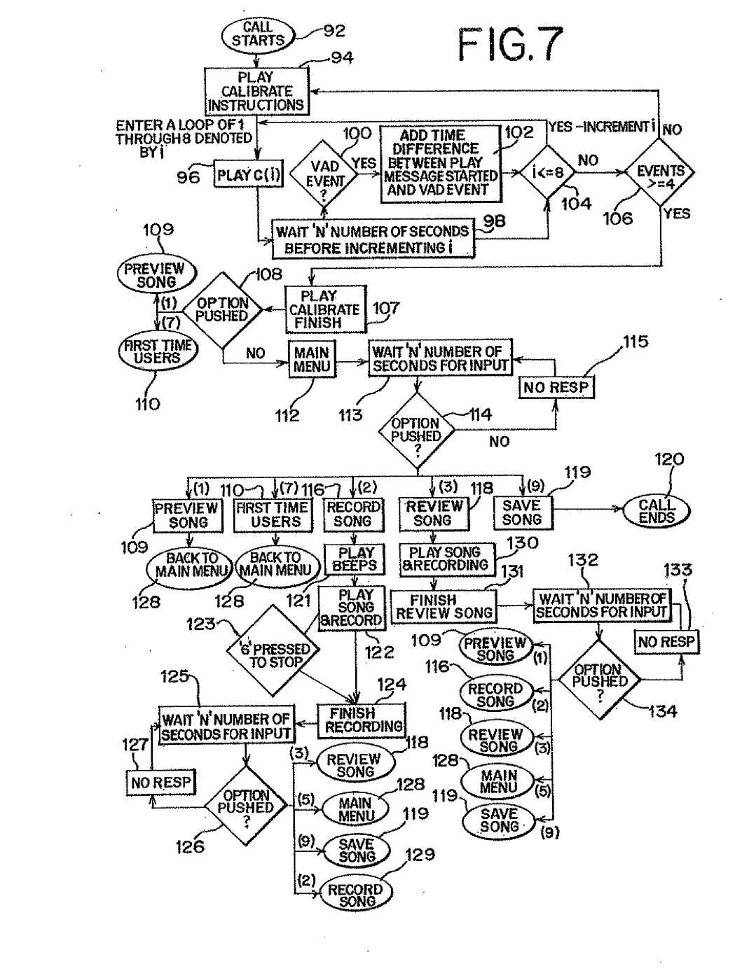

Four primary network latency correction methods have been developed to reduce or eliminate the effects of network latency to provide a quality recording experience to the end user. In the first such method, the platform is able to detect with fine precision when the user starts or stops speaking. This functionality is used along with a metered click track (i.e. an identifiable count such as 1 . . . 2 . . . 3 . . . 4) to measure the per call latency level and auto adjust the recording process with the per call latency settings. In this method, which is illustrated and described in further detail below with reference to FIG. 7, the user is asked to count along with the click track delivered to the handset and the error is averaged to determine the per call latency level.

In a second network latency correction method, during the initial installation of the platform, test calls are placed from various points in the wireless network. Average network latency can then be measured and is used to correct for network latency errors.

In a third network latency correction method, the IVR client application may contain mixing capabilities allowing the subscriber to simply adjust the track synchronization using the handset keypad (if necessary) during the review process.

In a fourth network latency correction method, user accepted network latency correction settings are stored on a per mobile directory number basis and used for correction of network latency errors for subsequent sessions.

Whether initiated by a WAP, WEB, MMS or SMS session, the IVR subsystem handles the actual process of recording, mixing and saving the karaoke style content during the studio session. The platform may dial out to the user provided telephone number and initiate the studio session. Alternatively, the user may call into the platform as an option to initiate the studio session. The implementation may utilize dual tone multi-frequency (DTMF) input and/or voice recognition for user responses through use of known technologies throughout the studio session.

For illustrative purposes, DTMF inputs are shown in FIG. 7, which illustrates a basic call flow for carrying out the studio session process. After the start of the call, at 92, the calibration technique begins by providing calibration instructions to the user, at 94. A count is then played, at 96, and a predetermined delay period is initiated, at 98, while a voice detection function is carried out, at 100. If a voice is detected, an event counter is incremented and the difference between the start of the play message for the count and the detection of the voice is recorded and used for the network latency correction, at 102. As determined at 104, provided the count has not reached a predetermined minimum (illustrated in this example as being eight measured beats), the count is incremented for the calibration session. Thereafter, the next count is played, at 96. If no voice is detected during the delay period, the count is incremented and the next count is played without incrementing the event counter. Upon completion of the predetermined minimum number of measured beats, it is determined at 106 whether a minimum threshold of user input/events has been obtained to accurately determine network latency for a given call. If the system does not detect the minimal number of data points the user is instructed to continue with the calibration routine, until the minimum dataset is established.

Once the calibration routine is finished, as shown by 107, the user is presented with options, at 108, to preview their underlying track selection at 109, or hear detailed usage instructions for first time users at 110. After preview or instructions are complete the user is placed within the main recording loop at 112-115. Here, the user is presented with the additional options to record a tone 116, review a recorded tone 118, or save their recorded tone and exit 119-120. If the user chooses to record a song at 116, initiation beeps are preferably played 121. and then the underlying track is played to permit the user to record the karaoke style content 122. The user may terminate the recording at any time by providing the proper input 123. Upon termination of the recording 124, a menu is provided at 125-127 to the user permitting the user to review the song 118, go back to the main menu 128, save the recording 119 or re-record the recording 129. At the main menu 112-115, should the user desire to review the recording, the user inputs the appropriate command at 118 and causes the recorded karaoke style audio file to be played for review at 130-131. Thereafter, a menu is provided to the user at 132-134 permitting the user to preview the underlying track 109, re-record the recording 129, review the recording 118, go back to the main menu 128 or save the recording 119. If the user chooses to save the recorded karaoke style recording at 119, it is saved as a karaoke style audio file for later use as a ringback tone and/or for download to the user handset for use as a ringtone.

Three primary IP based clients for karaoke style ringback and ringtone creation are referred to herein. The underlying platforms for each are preferably unique to their technologies. However, they preferably share the same IP infrastructure and capabilities as described below. A PC client based application can be employed. In addition, two handset client applications can be employed, including a BREW based application for CDMA handset clients and a J2ME based application for GSM handset clients. Preferably, an HTTP/XML protocol is used for data transmissions between the clients and the platform, as this protocol is most ubiquitously supported across hardware platforms and software development tool kits. It will be appreciated, however, that the use of additional and/or replacement protocols or software frameworks utilizing the same basic structure is possible. It should be recognized that although only Java and BREW based application frameworks are referenced herein, it would be possible to extend the service logic to a client in a different software framework.

These IP based client applications preferably share a menu driven graphical user interface (GUI) which largely mimics the web functionality used in the web based driven IVR method. Users are presented with the options to preview, select, review, record and save their content choices. With all of these examples, the client application works analogously with the browser client outlined above, making requests by using http protocol and receiving data in response to such requests. The IP based applications differ from the IVR based applications in that they allow for the recording and mixing capabilities to reside within the application itself. This may be desirable for a number of reasons, including the elimination of network based latency and the reduction in network resources required. In addition, in the personal computer based applications, use thereof employs the inherent audio capabilities of the personal computer (e.g., speaker and microphone) to provide functionally equivalent service.

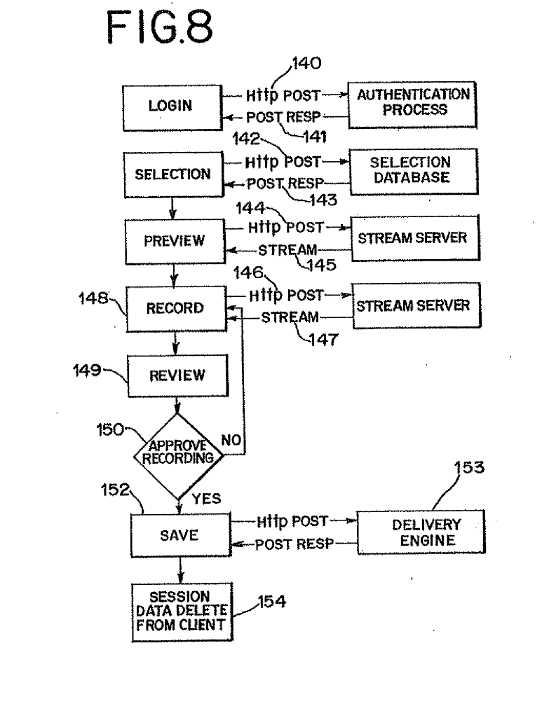

Preferably, these three referenced IP client applications share an identical call flow model illustrated by FIG. 8. In FIG. 8, the methods of communication between the client application (left side) and the server applications (right side) are http protocol based XML communication. Nonetheless, it will be appreciated that other client/server architectures could be used.

As shown in FIG. 8, the client application begins with the initialization of the application on the user's device. At this time, the application will alternately allow the user to enter the user login credentials, or send those credentials pre-entered and stored within the application utilizing the HTTP protocol containing an appropriately formatted XML document, at 140. The login credentials are authenticated at 141. In all three identified IP based client applications, streaming technology is used for both preview and recording. This allows the client application to store the recorded karaoke style audio file in volatile memory, which cannot be accessed outside of the application, or once the application has been closed. The song selection is made at 142-143 and the song may be previewed at 144-145. Thereafter, the recording process proceeds when the client requests recording stream from the server side stream resource, at 146. An IP data stream 147 is initiated from streaming server to the client. The client utilizes its internal sound devices to play the stream (underlying musical track) and to record the user input (i.e. singing) creating a mixed karaoke style audio file, at 148. The recorded karaoke style can be reviewed for approval, at 149-150, and once approved, it may be saved 152 and delivered to the platform delivery engine 153 for subsequent use as a karaoke style ringback tone and/or for delivery to the handset for use as a karaoke style ringtone. Therafter, the client application removes all trace of the stream and recorded content from the client interface, at 154.

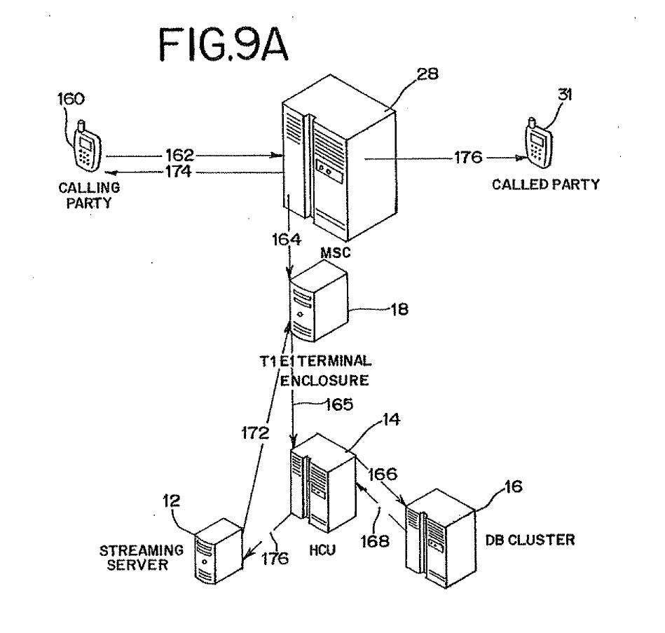

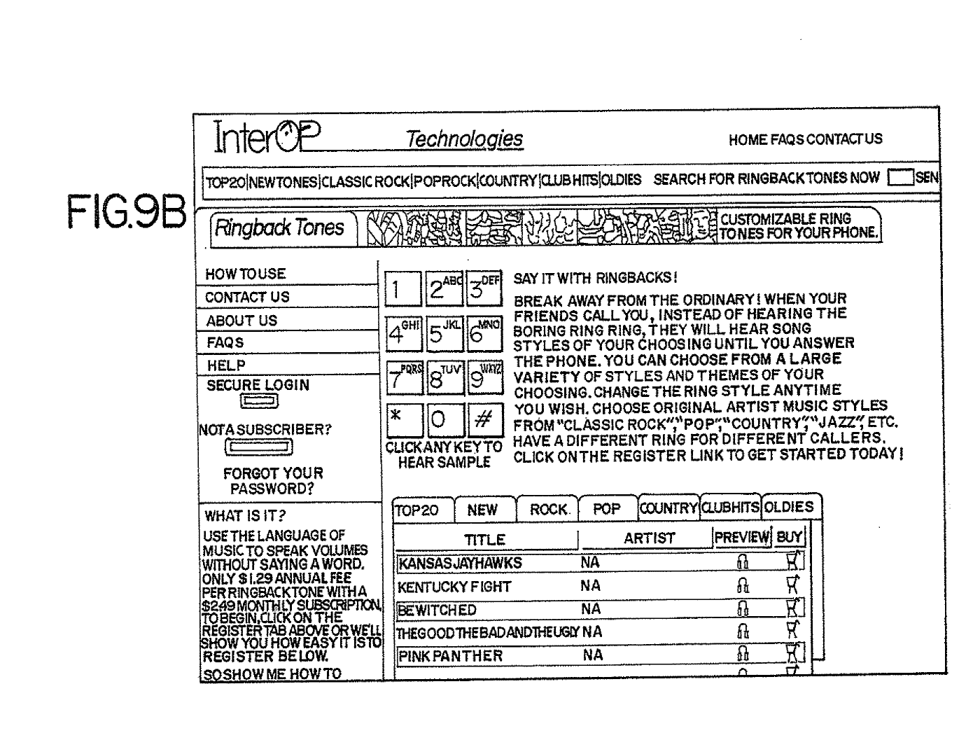

FIG. 9A illustrates an example of how the created karaoke style recording, when stored on the streaming server, can be used as a ringback tone. In this example, the karaoke platform serves as the ringback tone platform. It should be noted that in the case of use as a ringtone, the karaoke style recording is delivered to the handset for such use. As described herein, the karaoke platform and network based components interact to achieve ringback functionality.

FIG. 9A shows that a calling party 160 may place a call to a ringback tone enabled user 31, at 162. The mobile switching center (MSC) 28 places an ISUP call to the host control unit 14 via the cPCI blade enclosure 18, at 164-165. The HCU 14 queries the database cluster 16 for the user profile to determine proper ringback tone based on calling party 160, time of day, etc., at 166. Information regarding the identification of the proper tone and its location as stored on the streaming server 12 is sent to the host control unit 14, at 168. The host control unit 14 answers the call and instructs the streaming server 12 to play back the appropriate karaoke style recording corresponding to the selected ringback tone over the selected time division multiplexing circuit, at 170. The streaming server 12 connects and plays the selected karaoke style ringback tone audio file, at 172. The file is played and the ringback tone can be heard by the calling party 31, at 174. The MSC 28 attempts to connect to the called party 31 and the ringback tone is played until there is an appropriate response to the call triggering termination of the ringback playback process, at 176.

The user interface includes caller groups functionality, provides for ringback tone gifting, and includes a caller greeting (user recorded pre-tone greeting). The user interface has an interface that permits upload of user owned content for ringback tone use. The interface permits the creation and management of user-defined play lists and also permits shuffle play for ringback tones (randomized play back from a play list).

Subscribers enjoy the ability to manage their contacts and content through a variety of conduits. Extensive Web, WAP, SMS, and IVR interfaces are provided to maximize end user control and provide on demand service personalization. This allows subscribers to manage their own ringback content.

Operators can boost their average rate per unit (ARPU). Monthly recurring service subscriptions and content revenue sharing make the invention a valuable addition to any carrier's product portfolio.

Specific ringbacks may be played based on caller, caller group, time of day, day of week or any combination thereof. The ringback platform supports carrier defined expiration dates for content, creating additional revenue as subscribers replenish their accounts.

A carrier content administration system allows content administrators to access, preview and publish new content to their ringback tone platform's content libraries using a simple and intuitive web based tool. The control systems preferably push new content to the streaming servers during times of the day when available bandwidth is high. The control systems notify the content administrator that the new content is available. The carrier's content administrator then, via a simple interface, specifies whether the content is to be made available to its customers or not and how it is to be categorized. The carrier content administration system can be built utilizing simple open application protocol interfaces and standard internet transport technologies so that it can interface with a variety of content providers.

Subscribers receive a personalized call directory allowing them to mix and match original recordings, music, true-tones, sounds, sports anthems, voice-tones, etc. to each unique caller. Subscribers can configure their service based on day, time of day, caller identification, and caller group. Subscribers can provision themselves, requiring practically no customer care support. Subscribers can assign and match music genre with family, friends and other calling parties. Subscribers can manage their experience through a secure, password protected interface, IVE, SMS, or WAP session. Subscribers can toggle a sub-ringback tone traditional ringing sound on and off per ringback file per customer, so that callers unfamiliar with ringback service will not mistake a ringback tone for a wrong number.

An example of a graphical user interface illustrated as a web-based interface for implementation of the ringback tone system is illustrated in FIG. 9B.

In the case where there is an existing (legacy) ringback tone platform, the karaoke platform described herein may be integrated therewith. Two such ways are described herein, and the choice of which is preferred is dependent on carrier preference and/or constraints of the legacy ringback tone platform. As described above, the karaoke style recording may be delivered directly to the handset for use as a ringtone.

In the first configuration, the karaoke platform may be utilized as a stand-alone karaoke style recording creation platform. In this stand-alone configuration, the karaoke platform is used for the creation of the karaoke content only. This method relies on the underlying capabilities of the legacy ringback tone platform for storage of the karaoke style recording and playback of that file when the recording is to be used as a ringback tone. There are two main functional requirements this configuration places upon a legacy ringback tone platform. These functions may be carried out by the legacy ringback tone platform, or by alteration thereof. In the case where alteration is required, typically the alteration will be minimal.

The legacy ringback tone platform must provide API's for the delivery (preferably upload) of the finished content pieces to the storage device. Under most circumstances the same API which is used by third party content providers to the legacy ringback tone platform may be utilized, with no additional changes necessary.

The legacy ringback tone platform must also provide an API (or perhaps use one provided by the karaoke tone provider) to allow for the karaoke style recording title to be added to the user library. In most cases this can be achieved by remote procedure calls in which the karaoke platform informs the legacy ringback tone platform of the user account, title and location of the karaoke style recording. The legacy ringback tone platform can then carry out the functions of selection of the karaoke style recording and playback as a ringback tone using its normal methodologies.

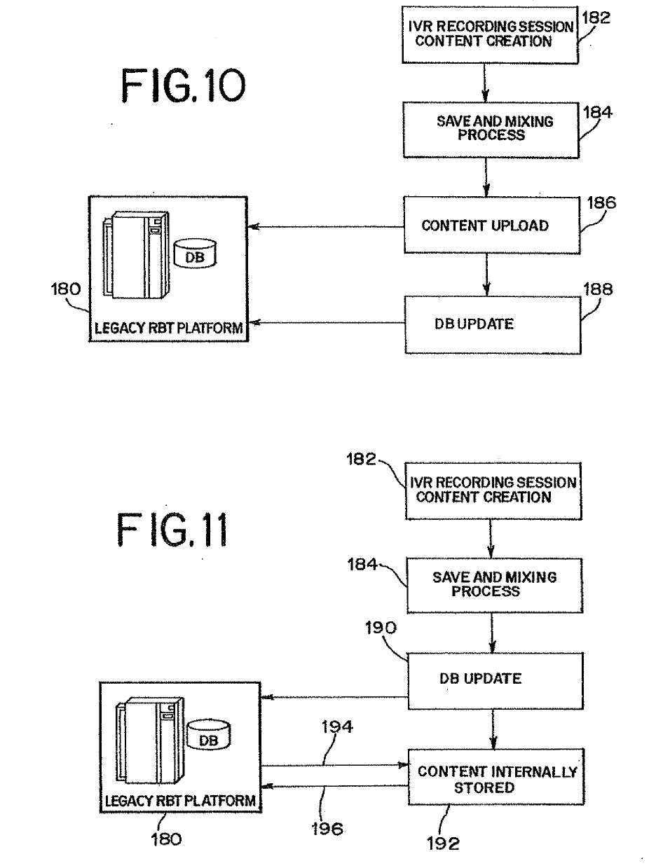

FIG. 10 illustrates a functional diagram demonstrating use of the karaoke platform as a stand-alone karaoke style recording creation platform. A legacy ringback tone platform is illustrated therein and designated by reference numeral 180. At 182, the studio session process is commenced. At 184, the user completes the recording process and the karaoke platform causes the underlying selected track to be mixed with the voice track created by the user into a single file referred to as a karaoke style recording. The karaoke style recording is preferably in a format consistent with the native content type of the legacy ringback tone platform. At 186, the karaoke style recording is delivered from the karaoke platform to the legacy ringback tone platform using conventional procedures, such as standard upload procedures. At 188, the karaoke platform causes the database of the legacy ringback tone platform to be updated by delivery of data indicative of the specific mobile directory number to be associated with the delivered karaoke style recording. Remote procedure calls (RPC) may be used for that purpose. The karaoke style recording is then ready for use as a ringback tone, as desired.

In the second configuration, the karaoke platform may be integrated with a legacy ringback tone platform in a manner such that the karaoke platform is used to create the karaoke style recording and, when it is desired to use such recording as a ringback tone, the karaoke platform is used to store the karaoke style recording for such use. This configuration is desired in those instances where the legacy ringback tone platform lacks the required capacity for storage of the karaoke style recording for use as a ringback tone. Legacy ringback tone platforms will frequently have inherent storage capacity limitations that prevent them from being used for storage of the karaoke style recording. In such instances, the karaoke platform will have a preferred creation and storage configuration which houses the completed karaoke style recording within one or more of the streaming servers associated with the karaoke platform. Consequently, the legacy ringback platform will have the ability to provide for the playback of karaoke style recording as a ringback tone, as desired, without impacting normal ringback tone functionality.

In this configuration, the karaoke platform will act as the content creation platform as above, but will also store the completed karaoke style recording in its own storage container. The legacy ringback tone platform must provide an API (or perhaps use one provided by the karaoke tone provider) to allow for the karaoke style recording title to be added to the user library. In most cases this is a simple remote procedure call in which the karaoke platform informs the legacy ringback tone platform of the user account, title and location of the karaoke style recording. At the time of playback, the legacy ringback tone platform will request a content stream of the recorded karaoke style recording from the appropriate streaming server(s) and utilize this as the ringback tone content. The streaming server(s) may utilize standard IP streaming protocols requiring little or no integration.

FIG. 11 illustrates a functional diagram demonstrating use of the karaoke platform as a karaoke style recording creation and storage platform. A legacy ringback tone platform is illustrated therein and designated by reference numeral 180. At 182, the studio session process is commenced. At 184, the user completes the recording process and the karaoke platform causes the underlying selected track to be mixed with the voice track created by the user into a single file referred to as a karaoke style recording. The karaoke style recording is preferably in a format consistent with the native content type of the legacy ringback tone platform. At 190, the karaoke platform causes the database of the legacy ringback tone platform to be updated by delivery of data indicative of the specific mobile directory number that will use the karaoke style recording and data indicative of the storage location within the streaming server(s) of the karaoke platform for the karaoke style recording. Remote procedure calls (RPC) may be used for that purpose. At 192, the karaoke platform saves the karaoke style recording to its streaming server(s). At 194, the legacy ringback tone platform requests the karaoke style recording for use as a ringback tone during call setup, as desired. This request may be made utilizing standard IP protocols and utilizing the appropriate API associated with the karaoke style recording. At 196, the karaoke platform responds to the request by initiating streamed playback of the karaoke style recording so that it may be used as a ringback tone, as desired.

While this invention has been described with reference to certain illustrative embodiments, it will be understood that this description shall not be construed in a limiting sense. Rather, various changes and modifications can be made to the illustrative embodiments without departing from the true spirit and scope of the invention, as defined by the following claims. Furthermore, it will be appreciated that any such changes and modifications will be recognized by those skilled in the art as an equivalent to one or more elements of the following claims, and shall be covered by such claims to the fullest extent permitted by law.

Where the terms comprise, comprises, comprised or comprising have been or are used herein, such terms are to be interpreted as specifying the presence of the stated features, integers, steps or components referred to, but not to preclude the presence, existence or addition of one or more other feature, integer, step, component or group thereof.

1. A method of permitting a telephone user to customize the identification of a call setup process to calling parties, comprising the steps of:
permitting the telephone user to create a karaoke style recording by causing an underlying musical track to be mixed with the voice of the user;
causing the karaoke style recording to be stored for later use as a ringback tone;
causing the karaoke style recording to be used as a ringback tone for a telephone number associated with the user to identify the call setup process to calling parties.

2. The method as defined by claim 1 wherein the user may select the underlying musical track from a plurality of available underlying musical tracks.

3. The method as defined by claim 1 wherein the step of permitting the telephone user to create a karaoke style recording is set up and conducted by utilizing messaging driven interactive voice response technologies.

4. The method as defined by claim 3 wherein the interactive voice response technologies utilize dual tone multi-frequency technologies.

5. The method as defined by claim 3 wherein the interactive voice response technologies utilize voice recognition technologies.

6. The method as defined by claim 3 wherein the user sings or otherwise speaks into the handset during a studio session for recordation of the karaoke style recording.

7. The method as defined by claim 6 further comprising the step of carrying out a network latency correction function for the karaoke style recording.

8. The method as defined by claim 1 wherein the step of permitting the telephone user to create a karaoke style recording is set up and conducted by utilizing web driven interactive voice response technologies.

9. The method as defined by claim 8 wherein the user sings or otherwise speaks into the handset during a studio session for recordation of the karaoke style recording.

10. The method as defined by claim 9 further comprising the step of carrying out a network latency correction function for the karaoke style recording.

11. The method as defined by claim 1 wherein the step of permitting the telephone user to create a karaoke style recording is set up and conducted by utilizing wireless application protocol driven interactive voice response technologies.

12. The method as defined by claim 11 wherein the user sings or otherwise speaks into the handset during a studio session for recordation of the karaoke style recording.

13. The method as defined by claim 12 further comprising the step of carrying out a network latency correction function for the karaoke style recording.

14. The method as defined by claim 1 wherein the step of permitting the telephone user to create a karaoke style recording is set up and conducted by utilizing IP protocol.

15. The method as defined by claim 14 wherein a personal computer and a personal computer client based application are used for setting up and conducting the creation of the karaoke style recording.

16. The method as defined by claim 15 wherein the user sings or otherwise speaks into a microphone associated with the personal computer during a studio session for recordation of the karaoke style recording.

17. The method as defined by claim 14 wherein the handset and a handset client based application are used for setting up and conducting the creation of the karaoke style recording.

18. The method as defined by claim 1 comprising the further step of permitting the user to permit review and comment regarding the karaoke style recording.

19. The method as defined by claim 18 wherein the user may permit review of the karaoke style recording through a publicly accessible webpage.

20. A method of permitting a telephone user to customize the identification of a call setup process upon receipt of calls from calling parties, comprising the steps of:
permitting the telephone user to create a karaoke style recording by causing an underlying musical track to be mixed with the voice of the user;
causing the karaoke style recording to be stored for later use as a ringtone;
causing the karaoke style recording to be used as a ringtone for a telephone number associated with the user to identify the call setup process.

21. The method as defined by claim 20 further comprising the step of delivering the karaoke style recording to the handset for storage and later use as a ringtone.

22. The method as defined by claim 20 wherein the user may select the underlying musical track from a plurality of available underlying musical tracks.

23. The method as defined by claim 20 wherein the step of permitting the telephone user to create a karaoke style recording is set up and conducted by utilizing messaging driven interactive voice response technologies.

24. The method as defined by claim 23 wherein the interactive voice response technologies utilize dual tone multi-frequency technologies.

25. The method as defined by claim 23 wherein the interactive voice response technologies utilize voice recognition technologies.

26. The method as defined by claim 23 wherein the user sings or otherwise speaks into the handset during a studio session for recordation of the karaoke style recording.

27. The method as defined by claim 26 further comprising the step of carrying out a network latency correction function for the karaoke style recording.

28. The method as defined by claim 20 wherein the step of permitting the telephone user to create a karaoke style recording is set up and conducted by utilizing web driven interactive voice response technologies.

29. The method as defined by claim 28 wherein the user sings or otherwise speaks into the handset during a studio session for recordation of the karaoke style recording.

30. The method as defined by claim 29 further comprising the step of carrying out a network latency correction function for the karaoke style recording.

31. The method as defined by claim 20 wherein the step of permitting the telephone user to create a karaoke style recording is set up and conducted by utilizing wireless application protocol driven interactive voice response technologies.

32. The method as defined by claim 31 wherein the user sings or otherwise speaks into the handset during a studio session for recordation of the karaoke style recording.

33. The method as defined by claim 32 further comprising the step of carrying out a network latency correction function for the karaoke style recording.

34. The method as defined by claim 20 wherein the step of permitting the telephone user to create a karaoke style recording is set up and conducted by utilizing IP protocol.

35. The method as defined by claim 34 wherein a personal computer and a personal computer client based application are used for setting up and conducting the creation of the karaoke style recording.

36. The method as defined by claim 35 wherein the user sings or otherwise speaks into a microphone associated with the personal computer during a studio session for recordation of the karaoke style recording.

37. The method as defined by claim 34 wherein the handset and a handset client based application are used for setting up and conducting the creation of the karaoke style recording.

38. The method as defined by claim 20 comprising the further step of permitting the user to permit review and comment regarding the karaoke style recording.

39. The method as defined by claim 38 wherein the user may permit review of the karaoke style recording through a publicly accessible webpage.
